(19) United States
(12) Patent Application Publication
(10) Pub. No.: US 2013/0103561 A1
(43) Pub. Date: Apr. 25, 2013

(54) INSIDER TRADING DETECTION

(71) Applicant: Justin Philip AMOS, London (GB)

(72) Inventor: Justin Philip AMOS, London (GB)

(73) Assignee: REDKITE FINANCIAL MARKETS LIMITED, Chertsey (GB)

(21) Appl. No.: 13/279,628

(22) Filed: Oct. 24, 2011

(51) Int. Cl. G06Q 40/04

(52) U.S. Cl. 705/37

(57) ABSTRACT

Detecting insider trading of financial instruments is described. In an embodiment news event data is received from a sentiment index where each news event has at least one associated rating of a relationship between the news event and the financial instrument. For example, a numerical rating of confidence that the news event will influence volatility of the financial instrument and a numerical rating of how related a news event is to a particular company. In examples the news events are filtered using the ratings and remaining news events are used to identify potential insider trading where a price of an order within a time period before the news event differs by more than a threshold amount from a characteristic of the market after the news event. Parameters such as the time period and the threshold may be automatically adjusted using feedback data or may be dynamically user adjusted.

### BACKGROUND

Financial institutions typically need to meet a high standard of scrutiny related to insider trading issues and need to demonstrate that diligent and thorough processes are in place to properly identify and respond to insider trading. Expensive and time consuming manual compliance processes and checks are typically undergone in order to meet these high standards. Some semi-manual risk compliance systems are available although these provide only a rudimentary tool for insider trading detection.

It is extremely difficult for insider trading to be detected in many situations, such as where a trader may use or knowingly possess material nonpublic information or where a breach of a family or other non-business relationship may give access to non-public information.

Where markets are volatile and rapidly changing it is especially difficult for compliance and risk management personnel at financial institutions to keep up with events in real time and quickly make a judgment as to whether an event is likely to be potential insider trading. In making such judgments large amounts of data are to be assimilated and understood and this requires highly skilled staff that are able to cope under pressure. Human error inevitably occurs in this type of situation.

The embodiments described below are not limited to implementations which solve any or all of the disadvantages of known insider trading detection systems.

### SUMMARY

The following presents a simplified summary of the disclosure in order to provide a basic understanding to the reader. This summary is not an extensive overview of the disclosure and it does not identify key/critical elements or delineate the scope of the specification. Its sole purpose is to present a selection of concepts disclosed herein in a simplified form as a prelude to the more detailed description that is presented later.

Detecting insider trading of financial instruments is described. In an embodiment news event data is received from a sentiment index where each news event has at least one associated rating of a relationship between the news event and the financial instrument. For example, a numerical rating of confidence that the news event will influence volatility of the financial instrument and a numerical rating of how related a news event is to a particular company. In examples the news events are filtered using the ratings and remaining news events are used to identify potential insider trading where a price of an order within a time period before the news event differs by more than a threshold amount from a characteristic of the market after the news event. Parameters such as the time period and the threshold may be automatically adjusted using feedback data or may be dynamically user adjusted.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of an alert system for insider trading detection;

FIG. 2 is a flow diagram of a method of insider trading detection;

FIG. 3 is a flow diagram of another method of insider trading detection;

FIG. 4 is a flow diagram of a method of dynamic parameter setting for an insider trading detection system;

FIG. 5 is a flow diagram of a replay method;

FIG. 6 is a schematic diagram of a web service providing insider trading detection;

FIG. 7 illustrates an exemplary computing-based device in which embodiments of an alert system for insider trading detection may be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

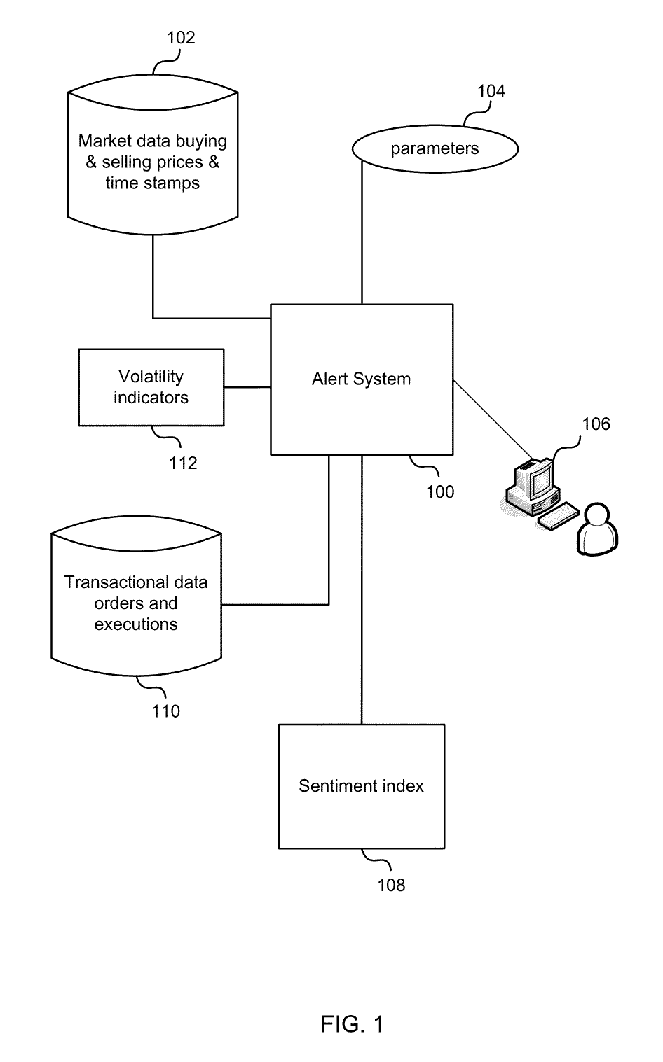

FIG. 1 is a schematic diagram of an alert system 100 for insider trading detection. The alert system 100 is computer implemented and able to access data from a plurality of sources which may be databases, real time feeds, web services, or other sources. For example, market data 102 is accessed from a database or other source in communication with the alert system 100. The market data comprises at least buying and selling prices of financial instruments and for each buying and selling price an associated time stamp indicating when the buying or selling price applied in a particular market. The market data may be for one specified market or may comprise market data from a plurality of different markets. In some examples the market data comprises an index of a market such as the FTSE 100 index where the market is the London Stock Exchange.

The alert system 100 optionally receives parameters 104 which may be user configurable. These parameters may comprise a variance threshold which enables the sensitivity of the alert system to be controlled, a look back period which controls how far back in time data is checked and other optional parameters. It is not essential for the parameters 104 to be user input; in some cases these parameters are set during a manufacturing stage and either remain constant or are adjusted automatically using a parameter setting engine as described in more detail later.

A user 106 at a personal computer, laptop, personal digital assistant, mobile telephone or other computing device is able to access a graphical user interface of the alert system in order to control the system, view and analyze alerts graphically overlaid with market data displays, create reports and configure parameters. In some examples the user is able to replay the alert system using historical data.

A sentiment index 108 is accessed from a real time feed, a database or other source in communication with the alert system 100. The sentiment index comprises one or more ratings each associated with a news event. The term “sentiment index” is used to refer to one or more ratings of a news event each on a specified scale where the ratings are determined at least in part using human judgment. The sentiment index may include news event data related to the news events that the ratings are associated with. For example, the news event data comprises, for each of a series of news events, a news event ID, a time stamp, one or more symbols of a financial instrument associated with the news event, and optionally a news event category. The associated ratings may comprise an impact score, a relevance score, a novelty score and optionally other scores relating to characteristics of the news event. The impact score may be a numerical score on a predefined scale which indicates the likelihood that the news item will influence volatility of the particular financial instrument. The impact score may have been derived from human judgments, or a combination of human judgments and automated analysis. The relevance score may be a numerical score on a predefined scale which indicates how strongly related the financial instrument is to the news story. For example, how strongly related stock A is to a news story that mentions company A and other companies in the same sector. The relevance score may have been derived from human judgments or a combination of human and automated processes. The novelty score may be a numerical score on a predefined scale which indicates how novel the news item is. The novelty score may be generated automatically by comparison with databases of historical news events or may be at least partly derived from human assessment.

Transactional data 110 is accessed from a database or other source in communication with the alert system 100. The transactional data comprises data about orders and optionally data about executions. For example, transactional data for an order may comprise: a client ID (i.e. identifier of the trader making the order), time stamp (time when the order was placed), symbol (identifier of the financial instrument on a particular stock exchange e.g. VOD for Vodafone on the London Stock Exchange), an order price, an order quantity, an order ID, an order type, a time period during which the order will remain in force (e.g. G—good for day), a side for the order (buy or sell side), and an order type.

In some examples the alert system 100 has access to volatility indicators 112. Any suitable volatility indicators may be used such as percentage change in price.

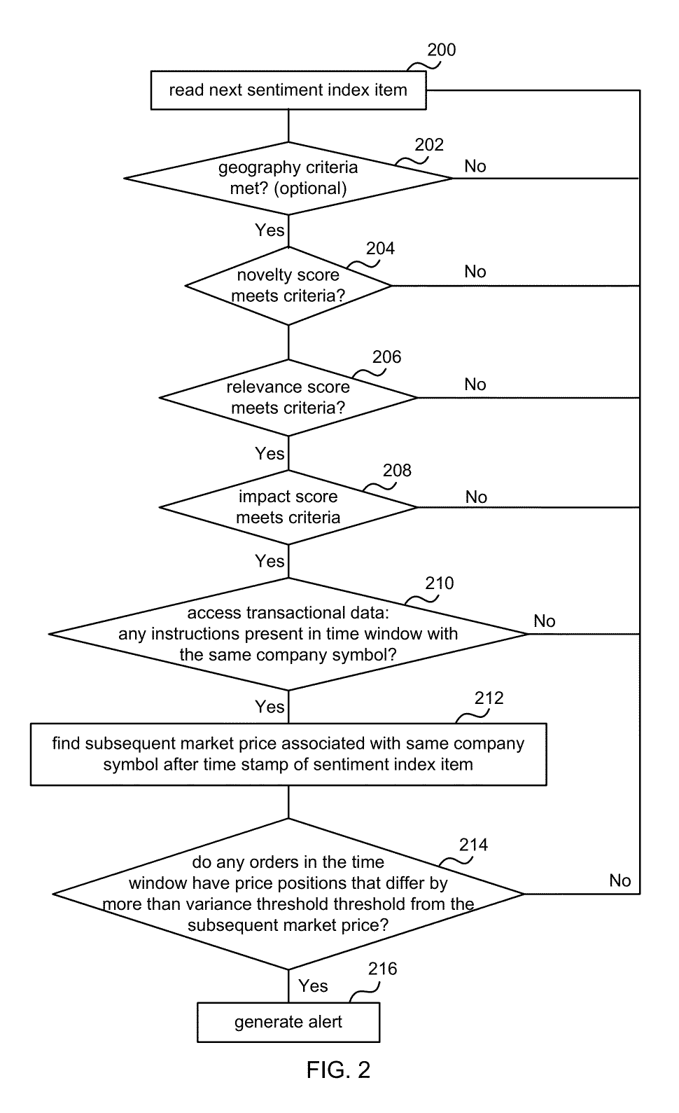

An example of a method at the alert system 100 of FIG. 1 is now described with reference to FIG. 2. A sentiment index item is read 200 or received from the sentiment index 108. As mentioned above, a sentiment index item comprises a news item ID, a time stamp, at least one rating of the news event, a symbol of a financial instrument associated with the news event, and optionally a news event category. The at least one rating may be an impact score, a relevance score, a novelty score and optionally other ratings of a relationship between the news event and a financial instrument which may be traded on a market. In some embodiments the sentiment index is received as a real time data stream.

An optional check is made as to whether any geography criteria are met 202. For example, if the alert system is to consider only trading on the London Stock Exchange then news events without associated symbols traded on that exchange are filtered out. A look up table or other mechanism may be used to identify which symbols of financial instruments are traded on which exchanges. If the geography criteria are not met the process returns to step 200.

An optional check is made as to whether a novelty score meets criteria 204. For example, a news item may have an associated novelty score indicating how new that news item is. If the news item is the third news item on a particular topic during a specified time (such as a day or week) the news item has a lower novelty score than the first of the news items on that topic during the specified time. The alert system 100 may comprise technology to analyse the news items and generate the novelty scores. In other examples the novelty score is obtained as part of the sentiment index. If the novelty criteria check fails then the process returns to step 200.

One or more ratings of the sentiment index are then used to identify news events that are to be analyzed further. A relevance score 206 may be checked to assess whether it meets criteria. Also, a news impact score 208 may be checked to assess whether it meets criteria. For example, whether the news impact score is over a threshold. In some embodiments only the impact score or only the relevance score is checked. In other embodiments both these scores are checked.

In some embodiments, news events that pass the sentiment index checks are used to identify transactions for analysis. Transactional data is accessed 210 and any instructions of a particular type that are present in a specified time window of the news event and with the same company symbol are selected. (The time window is also referred to as a look back period in some examples.) For example, the type of the instruction may be whether it is a buy side or sell side instruction. In an example, the type of the instruction is selected according to characteristics of the sentiment index. For example, where a positive impact score exists the type of the instruction selected may be buy side (to find buyers of a stock for which the sentiment of the news item is positive). Where a negative impact score exists the type of the instruction may be sell side (to find sellers of a stock for which is sentiment of the news item is negative). Each of the selected orders is compared with a characteristic of the market after the news event. For example, this characteristic may be the market price. In this case the subsequent market price associated with the same company symbol is found 212 from the market data. This is the price associated with the same company symbol after the time stamp of the sentiment index. For example, at the immediately subsequent time stamp or a time stamp a specified time interval after the time stamp of the sentiment index.

Each of the selected orders are then assessed 214 to check whether they have price positions which differ by more than a variance threshold from the subsequent market price. If so, an alert is generated 216 at a graphical user interface to prompt a user to check whether insider trading has taken place. The variance threshold may be user specified, pre-configured, or dynamically adjusted using a parameter setting engine as described in more detail below. In some embodiments the process of FIG. 2 is carried out in real time so that the sentiment index is received in real time and the alerts are generated as the news events of the sentiment index are received.

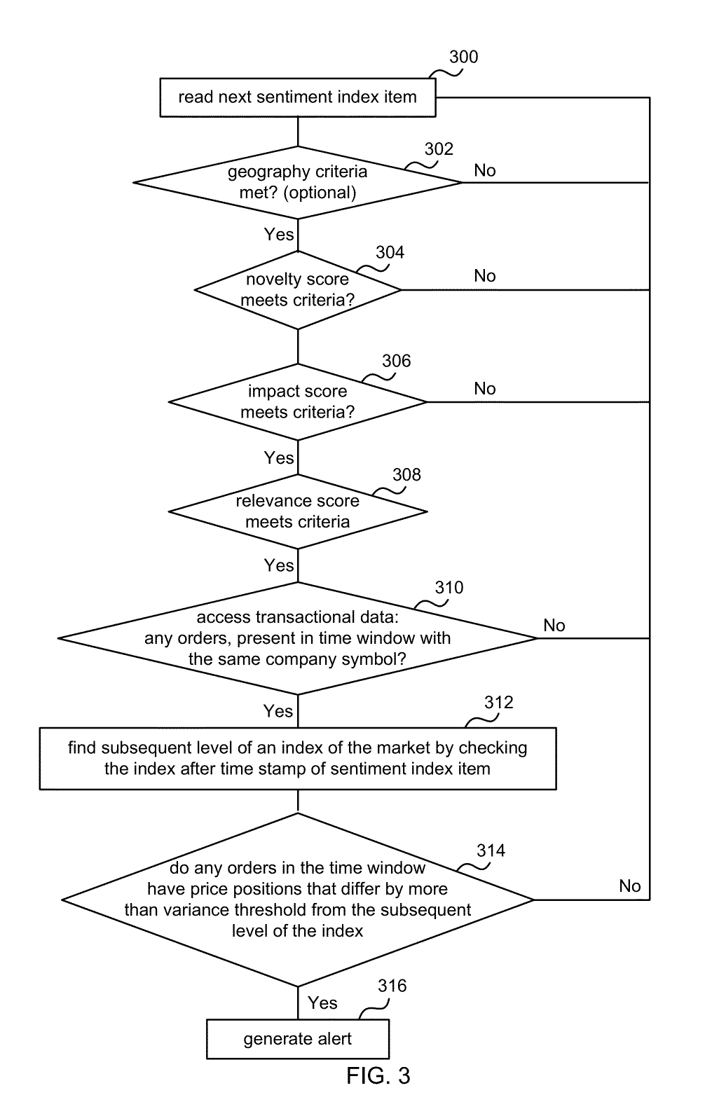

FIG. 3 is a flow diagram of another method at the alert system 100 of FIG. 1. In this example an index of the market is taken into account. For example, the index may the FTSE 100 index or any other suitable market index according to the particular market for which potential insider trading is being monitored. In some examples the method of FIG. 3 is carried out in real time.

A sentiment index item is read 300 or received from the sentiment index 108. An optional check is made as to whether any geography criteria are met 302. An optional check is made as to whether a novelty score meets criteria 304. One or more ratings of the sentiment index are then used to identify 306, 308 news events that are to be analyzed further. Transactional data is accessed 310 and any orders that are present in a specified time window of the news event and with the same company symbol are selected. The subsequent level of an index of the market is found 312 by checking the index after the time stamp of the sentiment index item. A check 314 is then made as to whether any orders in the time window have price positions that differ by more than a variance threshold from the subsequent level of the index. If so, an alert is generated 316 at the graphical user interface. It is also possible to take into account both the subsequent market price (method of FIG. 2) and the index of the market.

In an example, a sentiment index item is read which comprises a news event for company symbol AAA which is a profit warning announcement. Suppose that an insider trader had material information about the profit warning announcement before it occurred and placed a large order for stock of company AAA 4 days before the news event.

Suppose that the novelty score for the event is 100 as no previous profit warning announcement has been made that year. Suppose that the impact score for the event is 75 out of 100 where a score of 100 indicates highest confidence that the news story will have an impact on the volatility of the stock for company symbol AAA. Suppose that the relevance score for the event is 95 out of 100 indicating that the news event is significantly relevant to the company. In this situation the impact score criteria, relevance score criteria and novelty criteria may be met. Transactional data is accessed and suppose ten orders with the company symbol AAA are identified during a time window (or look back period) of 5 days before the news event. Only one of these 10 orders is the one made by the insider trader.

The subsequent level of an index of the market is obtained by checking the market index immediately after the time stamp of the news item. Suppose this level is x. The execution data for the 10 orders is obtained and a check is made as to whether any of those 10 orders have execution prices which differ by more than a variance threshold from level x.

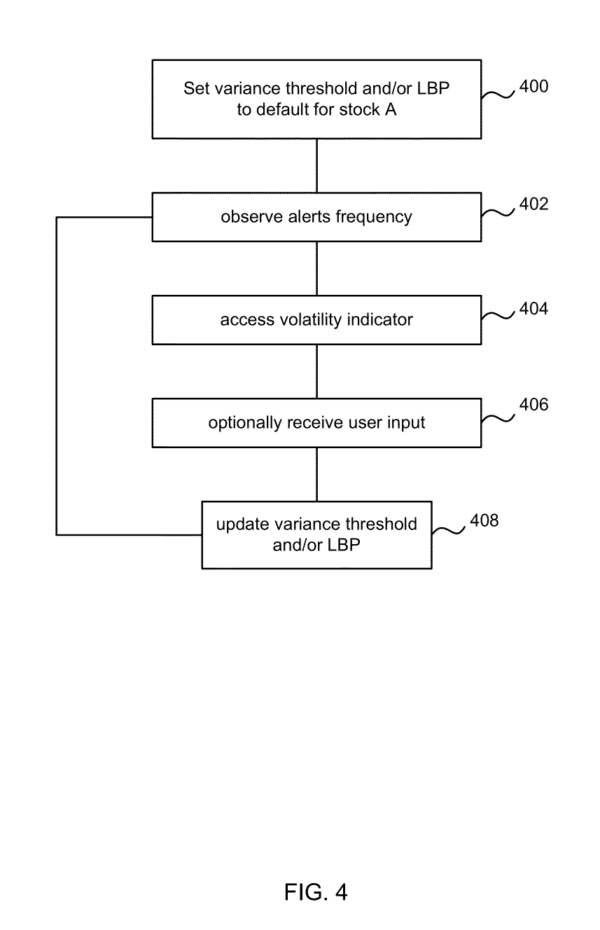

FIG. 4 is a flow diagram of a method of setting parameters of an alert system such as the alert system 100 of FIG. 1. As mentioned above parameters may comprise a variance threshold which enables the sensitivity of the alert system to be controlled, a look back period which controls how far back in time data is checked and other optional parameters such as the criteria for the geography, novelty score, impact score and relevance score assessments. In an example the variance threshold and look back period are user configured and may be adjusted by the user at the graphical user interface during use of the alert system whilst the criteria for the geography, novelty score, impact score and relevance score assessments are pre-configured at the manufacturing stage and remain constant. The variance threshold and look back period may be separately configured for each company symbol. In some embodiments it is possible to configure the variance threshold and look back period separately for each client ID or according to other factors. For example, if a particular client ID has been placed under a higher level of scrutiny.

In another example, the variance threshold and the look back period are automatically dynamically adjusted by a parameter setting engine at the alert system itself during operation. With reference to FIG. 4, the variance threshold and/or look back period (LBP) are set 400 to default values for stock A. A frequency of alerts generated by the alert system 100 is observed 402 and volatility indicators 404 are accessed which give information about volatility characteristics of the market concerned. In some examples, the observed alert frequency and volatility indicator information is used to update the variance threshold and/or look back period for stock A in a process that is transparent to the user. In other examples, a recommended update to the variance threshold and/or look back period is displayed at the graphical user interface. Any resulting user input 406 is then used to influence whether the recommended updates are implemented.

When an alert is generated, information associated with the alert and associated news event is stored and a user is able to review and analyze this information later using a plurality of tools at the graphical user interface. For example, the graphical user interface comprises an alert investigation screen which gives text based information about any alerts which have been generated in a given time period as well a graphical information. The graphical information may comprise a graphical display of market data with the ability to zoom into and out of that display to assess different time periods. Superimposed or adjacent to the graphical display of market data a graphical display of the alerts may be provided. For example, the news events associated with alerts may be indicated as flags on the graphically displayed market data such that when a user selects a flag more detail about the news event, and sentiment index information is displayed. A user is able to save the graphical information and alert information for access later as a case under investigation or closed.

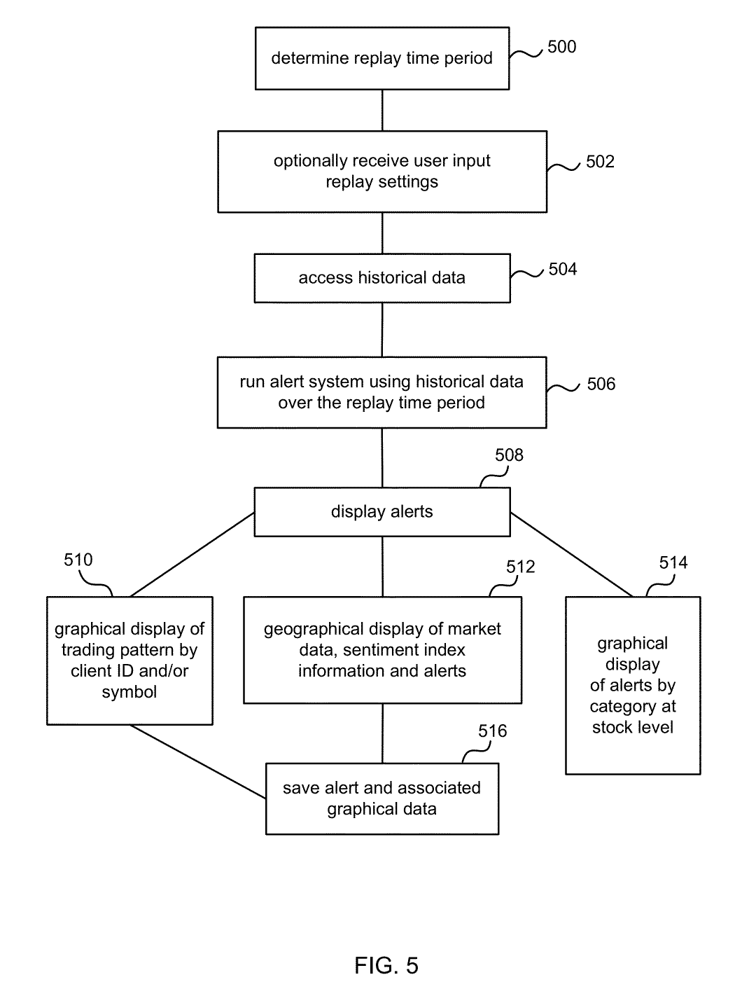

During investigation of an alert a user may replay the alert generation process with different parameter settings. With reference to FIG. 5 a replay time period is determined 500. For example, the user enters this information at the graphical user interface or a pre-determined time period from the time stamp of the alert is used. Optionally, user input is received 502 specifying the replay settings. For example, the values of the variance threshold and look back period for particular company symbols and/or client IDs are set. These may be automatically set in some examples. Historical data is accessed 504 for the market data, sentiment index, and transactional data. This historical data may have been stored at the alert system during the process when the original alert was generated or may be accessed from stores of historical data in communication with the alert system. The alert system is then run 506 using the historical data over the replay time period and with the replay settings. Any alerts are displayed 508 in a manner that indicates that they are replay alerts. A graphical display 512 of the market data, sentiment index information and the alerts (replay alerts and/or original alerts) may be given at the graphical user interface. The alerts and associated graphical data may be saved 516 at the alert system 100 or at any other suitable location. A graphical display of the trading pattern by client ID and/or company symbol 510 may be generated. Also, a graphical display of alerts by alert category at a stock level may be generated 514.

During investigation of an alert the user is able to review and analyze trading behavior for the particular financial instrument (e.g. stock) over a specified time period such as several months, for the particular client ID concerned. This time period may be referred to as a second look back period and may be user configurable or automatically set by the system. The insider trading detection system may be arranged to analyze frequency and size of any trading behavior which deviates from an index of the market.

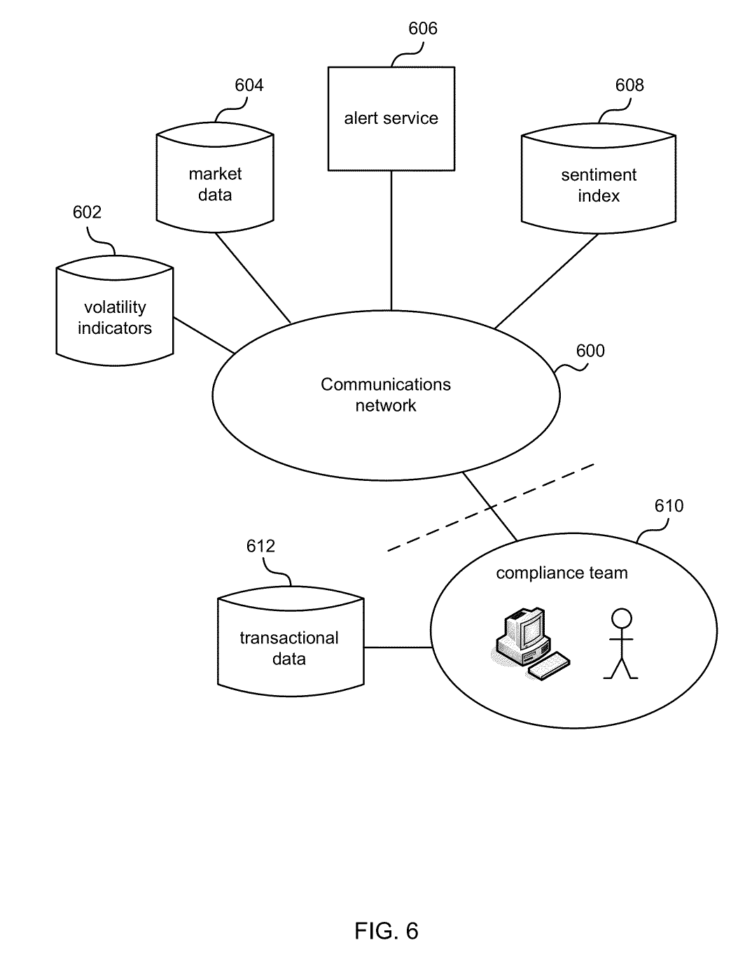

In an example an alert system for insider trading detection is provided as a web service as illustrated in FIG. 6. A compliance team 610 at a financial institution has access to transactional data 612 of the financial institution. The compliance team is able to access an alert service 606 over a communications network 600 such as the internet or any other communications network. The compliance team 610 may be protected by a firewall indicated by a dotted line in FIG. 6. The alert service 606 implements the functionality of the alert system 100 of FIG. 1 and any one or more of the methods described herein. It is able to access market data 604, sentiment index data 608 and optionally volatility indicators 602 from sources in communication with the communications network 600. The compliance team access the alert service 606 using a web based interface or in any other suitable manner and provide transactional data 612 in a secure form to the alert service 606. The alert service generates alerts and associated data and returns that to the compliance team using the web interface or other communications method.

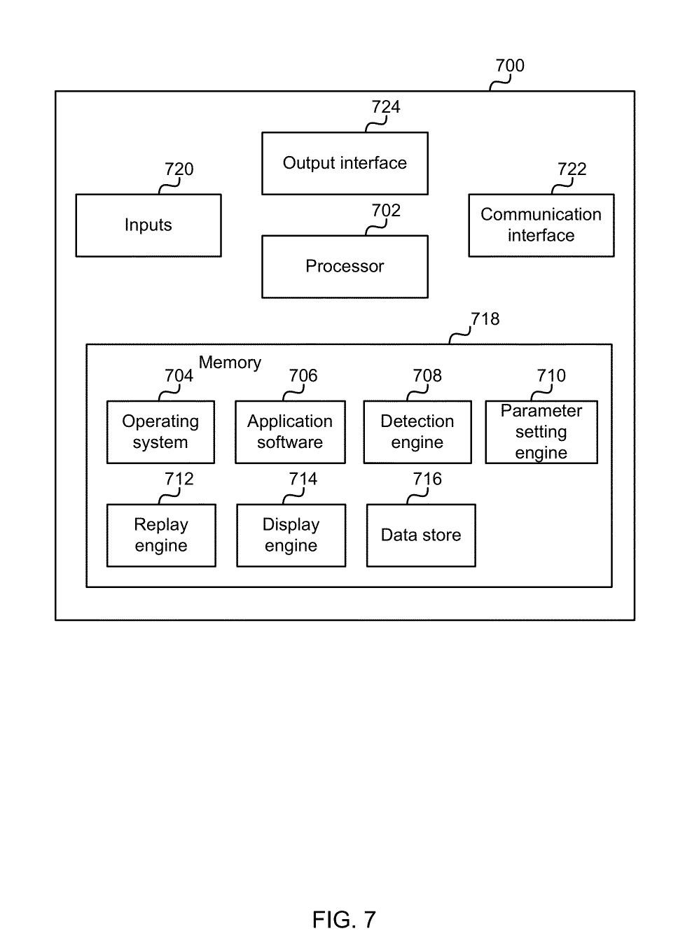

FIG. 7 illustrates various components of an exemplary computing-based device 700 which may be implemented as any form of a computing and/or electronic device, and in which embodiments of an alert system for insider trading detection may be implemented.

The computing-based device 700 comprises one or more inputs 720 which are of any suitable type for receiving market data, transactional data, sentiment index, volatility indicators, media content, Internet Protocol (IP) input, user input or other types of input. The device also comprises communication interface 722 to enable it to communicate with other computing devices over a communications network of any suitable type.

Computing-based device 700 also comprises one or more processors 702 which may be microprocessors, controllers or any other suitable type of processors for processing computer executable instructions to control the operation of the device in order to generate alerts related to potential insider trading. In some examples, for example where a system on a chip architecture is used, the processors 802 may include one or more fixed function blocks (also referred to as accelerators) which implement a part of the method of insider trading detection in hardware (rather than software or firmware). Platform software comprising an operating system 704 or any other suitable platform software may be provided at the computing-based device to enable application software 706 to be executed on the device.

The computer executable instructions may be provided using any computer-readable media that is accessible by computing based device 700. Computer-readable media may include, for example, computer storage media such as memory 718 and communications media. Computer storage media, such as memory 718, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Therefore, a computer storage medium should not be interpreted to be a propagating signal per se. Although the computer storage media (memory 718) is shown within the computing-based device 700 it will be appreciated that the storage may be distributed or located remotely and accessed via a network or other communication link (e.g. using communication interface 722).

An output interface 724 is also provided such as an audio and/or video output to a display system integral with or in communication with the computing-based device. The display system may provide a graphical user interface, or other user interface of any suitable type although this is not essential.

The term ‘computer’ is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants and many other devices.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible (or non-transitory) storage media include computer storage devices comprising computer-readable media such as disks, thumb drives, memory etc and do not include propagated signals. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A method, comprising:
receiving news event data and at least one associated rating of a relationship between the news event and a financial instrument which may be traded on a market;
checking that the at least one associated rating meets criteria;
identifying a plurality of orders for the financial instrument present in a time period defined according to a time stamp of the news event;
identifying, using a processor, an order from the plurality of orders as being potential insider trading by comparing a price position of the order with a characteristic of the market after the news event;
generating an alert for the order identified as being potential insider trading; and
displaying the alert at a display system, the alert comprising at least the associated rating.

2. The method of claim 1, further comprising:
receiving the news event data and the at least one associated rating in a real-time stream,
the alert being generated and displayed in real time for each order identified as being potential insider trading.

3. The method of claim 1, wherein the characteristic of the market is the price of the financial instrument in the market.

4. The method of claim 1, wherein the characteristic of the market is an index of the market.

5. The method of claim 1, wherein identifying the order from the plurality of orders as being potential insider trading comprises comparing a price position of the order with both a price of the financial instrument after the news event and an index of the market after the news event.

6. The method of claim 1, wherein the at least one associated rating is an impact rating indicating a confidence that a news event will influence volatility of the financial instrument.

7. The method of claim 1, wherein the at least one associated rating is a relevance rating indicating how strongly related to the news event the financial instrument is.

8. The method of claim 1, further comprising:
checking that the news event data meets a novelty condition by checking a novelty rating of the news event data.

9. The method of claim 8, further comprising:
calculating the novelty rating by comparing the news event data with historical news event data.

10. The method of claim 1, wherein the time period is defined according to a user input and the method further comprising receiving the user input.

11. The method of claim 1, wherein identifying the order includes identifying the order from the plurality of orders as being possible insider trading when the price position of the order differs by at least a variance threshold from a characteristic of the market after the news event.

12. The method of claim 11, further comprising updating the variance threshold automatically according to an observed frequency of identification of orders as being potential insider trading and according to a volatility indicator of the financial instrument.

13. A method comprising:
receiving historical news event data and at least one associated rating of a relationship between the news event and a financial instrument which may be traded on a market;
checking that the at least one associated rating meets criteria;
receiving user input specifying a look back period and a variance threshold;
identifying, a plurality of orders for the financial instrument present in the look back period immediately before the time stamp of the news event; and
identifying, using a processor, an order from the plurality of orders as being potential insider trading if a price position of the order differs by at least the variance threshold from a characteristic of the market after the news event.

14. The method of claim 13, further comprising:
generating a graphical display of prices of the financial instrument which also shows the news event data and at least one associated rating.

15. The method of claim 13, further comprising:
generating an alert that includes details of the news event, of the order identified as being potential insider trading, and of the at least one associated rating; and
displaying the alert at a graphical user interface.

16. The method of claim 14, comprising:
saving the graphical display and details of the news event, of the order identified as being potential insider trading, and of the at least one associated rating for use in a case display of a graphical user interface.

17. A system comprising:
an input arranged to receive news event data and at least one associated rating of a relationship between the news event and a financial instrument which may be traded on a market;
a processor arranged to check that the at least one associated rating meets criteria;
the processor being arranged to identify a plurality of orders for the financial instrument present in a time period defined according to a time stamp of the news event; and
the processor being arranged to identify an order from the plurality of orders as being potential insider trading by comparing a price position of the order with a characteristic of the market after the news event.

18. The system as of claim 17, further comprising:
a parameter setting engine arranged to automatically update a variance threshold using during the comparison process according to an observed frequency of identification of orders as being potential insider trading and according to a volatility indicator of the financial instrument.

19. The system of claim 17, further comprising:
a non-transitory memory arranged to store the order identified as being potential insider trading together with the news event data and the at least one associated rating.

20. A web browser application stored in a non-transitory processor readable memory and at least partially executed on a processor to perform the method as recited in claim 1.
